(19) United States
(12) Patent Application Publication
(10) Pub. No.: US 2024/0068849 A1
(43) Pub. Date: Feb. 29, 2024

(54) PROCESSING OF OPERATING DATA FROM A PLURALITY OF CONVEYOR LINES CONNECTED IN PARALLEL, WHERE EACH LINE HAS A FLOW RESISTANCE

(71) Applicants: KSB SE & Co. KGaA, Frankenthal (DE); SAMSON AKTIENGESELLSCHAFT, Frankfurt am Main (DE)

(72) Inventor: Stefan Unland, Rodgau (DE)

(21) Appl. No.: 18/261,469

(22) PCT Filed: Jan. 12, 2022
(86) PCT No.: PCT/EP2022/050550

§ 371 Date: Jul. 13, 2023

(30) Foreign Application Priority Data
Jan. 13, 2021 (DE) 10 2021 100 566.3

(51) Int. Cl. G01F 1/34; F17D 5/00

(52) U.S. Cl. CPC G01F 1/34; F17D 5/00

(57) ABSTRACT

The invention relates to a method (100) for processing operating data of a flow arrangement (2) of an apparatus (3) comprising a first conveying line (10) having a first flow resistor (11) and a second conveying line (20) having a second flow resistor (21) and being connected in parallel to the first conveying line (10) for a fluid flow (40) in the flow arrangement (2). Furthermore, the invention relates to a computer program product, and to a flow system (1).

The invention relates to a method for processing operating data of a flow arrangement, a computer program product, and a flow system.

In fluid cycles, assemblies are often used that include centrifugal pumps connected in parallel to generate flow. As a rule, these assemblies—similar to those of the other apparatus parts—are only used in such a way that the process goals set for the apparatus can be achieved. Further additional measurement technology for diagnosis or for assessing the operating modes of individual components or individual devices is only available in a few exceptional cases, particularly for cost reasons. As a result, the operating modes of individual pumps are largely unknown. This applies in particular to pump assemblies in which pumps of different design/configuration and performance are installed, since known models usually assume pumps of identical design/configuration and speed.

It is an object of the present invention to at least partially eliminate the aforementioned disadvantages known from the prior art. In particular, it is an object of the present invention to enable a processing of operating data, preferably independent of an efficiency and/or a current performance of flow machines of the flow arrangement, by a determination of a strand-related operating behavior of a flow arrangement with parallel-connected conveying lines.

The foregoing object is solved by a method having the features of claim 1, a computer program product having the features of claim 14, and a flow system having the features of claim 15. Further features and details of the invention result from the respective dependent claims, the description and the drawings. Features and details described in connection with the method according to the invention naturally also apply in connection with the computer program product according to the invention and/or the flow system according to the invention, and vice versa in each case, so that reference is or can always be made mutually with respect to the disclosure concerning the individual aspects of the invention.

According to a first aspect of the invention, there is provided a method of processing operating data of a flow arrangement of an apparatus. The flow arrangement comprises a first conveying line having a first flow resistor, and a second conveying line having a second flow resistor. Further, the second conveying line is connected in parallel with the first conveying line for a fluid flow in the flow arrangement, in particular hydraulically. The method comprises, in particular in the form of method steps/stages:
Detection of a resistance behavior of the flow arrangement with a first reference behavior of the first flow resistor and a second reference behavior of the second flow resistor, in particular by a reference module of a control device of a flow system,
Detection of a common operating behavior with at least or exactly one common operating parameter of the first conveying line and the second conveying line as a function of a current operating situation, in particular by a behavior module of the control device,
Determining a, preferably structureless, substitute model for determining a strand-related operating behavior of the flow arrangement, in which a mutual influence of the first conveying line, preferably a first operating behavior of the first conveying line, and the second conveying line, preferably a second operating behavior of the second conveying line, is taken into account as a function of the resistance behavior and the common operating behavior, in particular by a model module of the control device,
Determining the strand-related operating behavior of the flow arrangement for the current operating situation as a function of the substitute model, in particular by an evaluation module of the control device.

The processing of the operating data may preferably comprise an analysis of the operation of the flow arrangement. The flow apparatus is in particular a hydraulic apparatus. Thus, the arrangement may be a hydraulic arrangement. The fluid flow may be a liquid flow, preferably of an incompressible fluid such as water.

For the purposes of the present invention, the parallel connection of the first and second conveying lines for the fluid flow is understood to mean, in particular, a hydraulic parallel connection. The first and second conveying lines may each have at least one conduit section for guiding the fluid flow, in which the first flow resistor and the second flow resistor are arranged, respectively. The first and second conveying lines may thus have a common flow inlet and/or a common flow outlet. In this regard, for example, a flow cycle may comprise a branching into the first and second conveying lines at the flow inlet, and a merging of the fluid flow from the first and second conveying lines at the flow outlet. The first and/or second flow resistor may be formed by a valve or other restriction. It is conceivable that each of the conveying lines has a plurality of flow resistors that are hydraulically connected to each other in series or in parallel.

The first and/or second reference behavior preferably comprises at least one reference parameter in each case, which characterizes an influence of the first and/or second flow resistor on the fluid flow in the respective conveying line. It is conceivable that the first and/or second reference behavior in each case comprises a reference characteristic curve for characterizing an influence of the first and/or second flow resistor on the fluid flow in the respective conveying line.

The common operating parameter may comprise a pressure and/or flow parameter, in particular in the form of a pressure and/or flow ratio, in the flow arrangement, which is influenced by the first conveying line and the second conveying line. The common operating parameter may be measured and/or determined for a simulation of the current operating situation.

The detection of the resistance behavior and/or the detection of the common operating behavior can take place virtually and/or on the basis of real measured values. The resistance behavior and the common operating behavior can thus be, in particular predetermined and/or recognized, operating data. For example, the first reference behavior and/or the second reference behavior may each comprise at least one reference parameter that is detected by data and/or measurement when the resistance behavior is detected. Further, the common operating parameter may be acquired by data and/or measurement. The resistance behavior can be provided, for example, by a memory module of the control device.

The substitute model can advantageously be designed/configured as an analytical and/or structureless computational model, in particular without structural modeling of lines and/or structures of the components. Thus, it can be provided that the lines and the structures of the components are only considered by parameters and/or constants in the substitute model. Furthermore, it may be provided that the substitute model is designed/configured to be time-independent and/or to determine the strand-related operating behavior in an equilibrium state of the flow arrangement. By a time-independent execution of the substitute model it may be understood that the current operating situation may be limited to a specific point in time and that the substitute model therefore in particular does not comprise a function over several time steps/stages. Preferably, the substitute model is based on the current filament theory.

The substitute model can, for example, comprise a system of analytical equations. In this context, the system of equations and/or a structure of the system of equations may be predetermined. In particular, values of the resistance behavior and the common operating behavior can be inserted into the system of equations when determining the substitute model as a function of the resistance behavior and the common operating behavior.

However, it is equally conceivable that the system of equations is created, in particular as a function of the current operating situation and/or of a design/configuration of the flow arrangement, when determining the substitute model. It may be provided, for example, that the system of equations is compiled and/or parameterized, in particular starting from the structure. For example, when determining the substitute model, it may be provided that a number of equations and/or of terms of the equations for the substitute model are determined as a function of the current operating situation and/or of a design/configuration of the flow arrangement. By taking into account the influence of the first and second operating behavior, the first and second operating behavior may still be unknown when determining the substitute model. The mutual influence of the first and second operating behavior can, for example, be expressed by an equation, a constant and/or an equation term.

When determining the strand-related operating behavior, the substitute model can be resolved. The strand-related operating behavior can, for example, comprise the first operating behavior of the first conveying line and the second operating behavior of the second conveying line in the current operating situation. In particular, when determining the strand-related operating behavior, the first operating behavior can be calculated for the first conveying line and the second operating behavior can be calculated for the second conveying line, for example by calculating operating parameters that characterize the first operating behavior and the second operating behavior as a function of the substitute model.

Thus, a current configuration of the flow arrangement can be analyzed in knowledge of the resistance behavior and the common operating behavior. For example, individual operating parameters of the flow resistors and/or further components of the conveying lines can be identified and/or calculated. This makes it possible to process the operating data of the flow arrangement even if additional measurement technology is not provided for diagnosing or assessing the operating modes of individual components or individual devices in the conveying lines. This makes it possible, for example, to provide evidence of the current configuration of the flow arrangement for clarifying warranty issues without having to retrofit the apparatus. Advantageously, it can be detected, for example, whether the flow arrangement is being operated as designed/configured. Furthermore, it is conceivable that the processing of the operating data with the method is used to design/configure the flow arrangement.

Preferably, in a method according to the invention, it can be provided that the first conveying line has a first flow machine and the second conveying line has a second flow machine, preferably with the first flow machine being connected in series with the first flow resistor and/or the second flow machine being connected in series with the second flow resistor. In particular, the first flow machine is connected in series upstream of the first flow resistor in the direction of fluid flow and/or the second flow machine is connected in series upstream of the second flow resistor in the direction of fluid flow. Through the flow machines, an exchange of mechanical energy and flow energy of the fluid flow in the conveying lines can take place. Thus, the flow can be influenced differently by the first and second flow machines in each of the conveying lines. It is conceivable that when the resistance behavior and the common operating behavior are detected, the operating modes of the individual flow machines are unknown or predominantly unknown. In particular, it is conceivable that the first and second flow machines are designed/configured in the form of different machine models and/or with different maximum power capabilities. Furthermore, it is conceivable that the two flow machines are operated at different operating points. Due to the strand-related operating behavior and, in particular, the strand-related approach associated therewith, such information about the flow machines can be obtained, in particular without the need for an additional sensor system. Preferably, at least one machine-related operating parameter is calculated when determining the strand-related operating behavior.

It is further conceivable in a method according to the invention that the first flow machine and/or the second flow machine is designed/configured as a pump, preferably wherein the first flow machine and the second flow machine have different differential pressures in the form of delivery pressures for delivering the fluid flow in the current operating situation. Preferably, the first flow machine and/or the second flow machine may be designed/configured as a centrifugal pump. A delivery pressure can be understood as a pressure difference generated by the respective flow machine in the respective conveying line. Due to the parallel connection, however, the pressure ratio in the conveying lines can deviate from the contribution of the respective flow machine, in particular from the contribution of the flow machine with lower conveying capacity. To generate different delivery pressures, the turbomachines can be operated at different conveying capacities. The method thus makes it possible to determine the strand-related operating behavior also for pumps that provide an energy contribution to the flow. In particular, the strand-related operating behavior is determined regardless of which pumps make up the assembly or at which speeds the pumps are operated. The respective differential pressure at the first flow machine and/or at the second flow machine can preferably be calculated only when determining the common operating behavior. In particular, the strand-related operating behavior can thus comprise a strand-related operating mode.

It is also conceivable in a method according to the invention that the first flow resistor and the second flow resistor can each be brought into an opening state for allowing a flow, in particular in the respective conveying line, and a closing state for blocking a flow, in particular in the respective conveying line. Preferably, in the current operating situation, the first flow resistor or one of the two flow resistors is in the closing state and the second flow resistor or the other of the two flow resistors is in the opening state. In particular, the first and/or second flow resistor may be formed by one valve each. Taking into account the mutual influence of the first and second operating behavior of the two conveying lines in the substitute model also enables calculation of the strand-related operating behavior of the first and second conveying lines when the first or second flow resistor is in the closing state. In the closing state, fluid flow in the respective conveying line can be completely prevented or limited to a leakage flow.

Within the scope of the invention, it is further conceivable that the first reference behavior and/or the second reference behavior comprises, in particular in each case, a minimum reference parameter for characterizing the opening state and/or a maximum reference parameter for characterizing the closing state. The first and/or second reference behavior may in particular comprise a characteristic curve of the respective flow resistor, in particular for defining the first and/or second reference behavior by a pressure drop figure relative to a pressure difference prevailing at the respective flow resistor. In this context, the characteristic curve may have a slope that lies between the maximum and minimum reference parameters. It is further conceivable that the maximum reference parameter comprises a maximum pressure drop figure and/or the minimum reference parameter comprises a minimum pressure drop figure, in particular as a function of the characteristic curve. Thus, the opening state and/or the closing state can be characterized in the substitute model. By taking the first and second reference behaviors into account, the pressure conditions prevailing in the current operating situation at the flow resistors can be calculated when determining the strand-related operating behavior, in particular instead of measuring them in the flow apparatus.

Preferably, in a method according to the invention, it can be provided that the first flow resistor and the second flow resistor are each formed by a check valve. By means of the check valve, one of the conveying lines can be completely closed, in particular if a pump with a lower delivery rate is arranged in the respective conveying line. In particular, the check valves can be purely mechanically operating check valves that are transferred to the opening state in a specified flow direction from a predetermined differential pressure value, in particular an opening pressure inherent in the check valve. In particular, if the effective pressure of the flow medium is lower than the opening pressure of the check valve, provision can be made for the check valve to remain closed, for example, by means of a spring preload. In this case, the flow behavior in the closing state can be taken into account by a high pressure drop figure. If the differential pressure at the check valve exceeds the opening pressure, the check valve can be opened. The transfer of the respective check valve from the opening state to the closing state and vice versa can be taken into account as a continuous process in the substitute model, in particular in which the degree of opening depends on the differential pressure. In particular, the pressure drop figure remains constant when the check valve is fully open and assumes a value of the minimum reference parameter. As a result, even a fully closed conveying line can be advantageously taken into account in the substitute model and when determining the strand-related operating behavior.

Furthermore, in a method according to the invention, it may advantageously be provided that the flow arrangement has a flow inlet and a flow outlet, wherein the common operating behavior comprises a pressure difference between the flow inlet and the flow outlet and/or a volume flow at the flow inlet and/or at the flow outlet. In particular, the pressure difference and/or the volume flow rate may form the common operating parameter. Preferably, only one common operating parameter is provided to be included in the substitute model. For example, it may be sufficient if the volume flow and/or the pressure difference is known in order to calculate the strand-related operating behavior.

Furthermore, in a method according to the invention, it is conceivable that the mutual influence of the first conveying line and the second conveying line is taken into account in the substitute model by means of a differential pressure direction at the first flow resistor and at the second flow resistor, respectively. By means of the differential pressure direction, a pressure loss and/or a pressure gain of the respective conveying line, in particular at the flow resistor, can be taken into account in the substitute model. It has been recognized in the context of the present invention that by means of the differential pressure direction in the substitute model, an increase of a lower delivery pressure of one of the conveying line to a higher delivery pressure of the respective other conveying line can be taken into account. As a result, the strand-related operating behavior of the flow arrangement can be calculated even with different delivery pressures in the conveying lines. Advantageously, it can be provided that the substitute model comprises a system of equations in which a change of sign of a differential pressure in the first conveying line and/or in the second conveying line is taken into account. The sign change can be taken into account in the substitute model in the form of a function, in particular a signum function. The signum function can, for example, be implemented as a function of the volume flow at the flow inlet and/or at the flow outlet. Thus, for example, a case discrimination controlled by a user is not necessary. To take into account negative values of differential pressures at the flow resistor, an equation for describing the first and/or second reference behavior, in particular in the substitute model, can have a hyperbolic function, preferably in the form of a tangent hyperbolic.

Preferably, in a method according to the invention, it can be provided that, when determining the strand-related operating behavior, at least one, several or all of the following operating parameters of the flow arrangement are calculated for the first conveying line and the second conveying line of the current operating situation:
Strand-related volume flow,
Differential pressure at the first flow resistor and/or at the second flow resistor,
Differential pressure at the first flow machine and/or at the second flow machine,
Strand-related delivery head, in particular of the first flow machine and/or the second flow machine,
Pressure drop figure for the first flow resistor and/or the second flow resistor.

Thereby, the operating parameters for each of the conveying lines can be determined when determining the strand-related operating behavior. Thus, the volume flow is in particular a volume flow of the fluid flow in the respective conveying line. In particular, the differential pressure comprises a pressure difference of the fluid flow between an inlet and an outlet of the respective flow resistor and/or the respective flow machine. The differential pressure at the respective flow machine may in particular also be referred to as the delivery pressure of the flow machine. The strand-related delivery head may comprise, for example, a zero delivery head of the pump arranged in the respective conveying line, in particular related to a ratio of a rotational speed of the pump to a nominal rotational speed of the pump. The pressure drop figure at the first and/or second flow resistor relates in particular to the current operating situation. Preferably, all of the listed operating parameters can be calculated using the substitute model when determining the strand-related operating behavior.

Furthermore, in a method according to the invention, it can be advantageously provided that the determination of the strand-related operating behavior, in particular as a function of a predefined initial condition, is performed iteratively. In particular, the substitute model may be non-linear. For the iterative determination of the strand-related operating behavior, a Gauss-Seidel-Newton method can preferably be executed for the substitute model. The iterative procedure allows the substitute model to be solved automatically in order to determine the strand-related operating behavior, in particular numerically.

Preferably, in a method according to the invention, it can be provided that the flow arrangement has at least a third conveying line with a third flow resistor, which is connected in parallel with the first conveying line and second conveying line, a third reference behavior of the third flow resistor being detected when the resistance behavior is detected.

Preferably, a third flow machine, in particular in the form of a pump, is connected in series with the third flow resistor in the third conveying line. Furthermore, it can be provided that the flow arrangement has further conveying lines with further flow resistors, and preferably flow machines connected in series therewith, which are each connected in parallel with the first conveying line and second conveying line, in each case a further reference behavior of the further flow resistors being detected when the resistance behavior is detected. As the number of conveying lines increases, determining the strand-related operating behavior becomes more complex. This complexity can be handled by the substitute model. In particular, the substitute model can avoid the need for manual case discrimination of the differential pressure direction for each of the conveying lines. As a result, the strand-related operating behavior of an unknown configuration of the flow arrangement can be determined, in particular in an automated manner.

Preferably, a method according to the invention may provide that the common operating parameter is measured in the apparatus or is provided virtually. In particular, the common operating parameter may comprise, for example, a measured value or a default value that is provided, for example, as a function of a user input. By measuring the common operating parameter, for example, an existing flow arrangement of the apparatus can be analyzed. By providing the common operating parameter virtually, the method can simulate the flow arrangement, for example. It is conceivable that the common operating parameter is provided by a soft sensor system. The soft sensor system can be designed/configured as a dependency simulation of representative measured variables to a target variable, and thus in particular be independent of real existing sensors.

Preferably, in a method according to the invention, it can be provided that a reaction process, in particular by a reaction module of the control device, is carried out as a function of the strand-related operating behavior, in particular wherein the reaction process comprises a control of the flow machines, an output of a service life forecast for the flow arrangement and/or a display of the strand-related operating behavior on an operating device of the apparatus. For example, the method may be performed by a control device that is in data communication with the flow machines for controlling the flow machines. The output of the service life forecast and/or the display of the strand-related operating behavior may be performed at the operating device. The operating device may be part of the apparatus and/or the flow arrangement. For example, the operating device may be integrated into a control station of the apparatus. By displaying the strand-related operating behavior, an operator can gain direct insight into the current operating situation in order to intervene if necessary. The service life forecast can be generated to output the service life forecast. Here, the service life for each of the flow machines and/or each of the flow resistors can be calculated as a function of the strand-related operating behavior.

According to another aspect of the invention, a computer program product is provided. The computer program product comprises instructions which, when executed by a control device, cause the control device to execute a method according to the invention.

Thus, a computer program product according to the invention has the same advantages as have already been described in detail with reference to a method according to the invention.

In particular, the method may be a computer-implemented method. The computer program product may be implemented as computer-readable instruction code. Further, the computer program product may be stored on a computer-readable storage medium such as a data disk, a removable drive, a volatile or non-volatile memory, or a built-in memory/processor. Further, the computer program product may be deployable or provided on a network, such as the Internet, from which it may be downloaded or executed online by a user as needed. The computer program product may be implemented by means of software, as well as by means of one or more special electronic circuits, i.e., in hardware, or in any hybrid form, i.e., by means of software components and hardware components.

According to another aspect of the invention, a flow system is provided. The flow system has an apparatus with a flow arrangement comprising a first conveying line having a first flow resistor and a second conveying line having a second flow resistor and connected in parallel with the first conveying line for a fluid flow in the flow arrangement. Further, the flow system comprises a control device for carrying out a method according to the invention.

Thus, a flow system according to the invention brings the same advantages as have already been described in detail with reference to a method and/or computer program product according to the invention. In particular, when the flow arrangement includes flow machines in the form of pumps, the flow system may also be referred to as a hydraulic system. The control device may be integrated into an external server, in particular into a cloud. However, it is equally conceivable that the apparatus comprises the control device. For example, the control device may be integrated into a control station of the apparatus and/or a control device for the flow machines of the flow arrangement. Preferably, the control device comprises a processor and/or microprocessor for executing the method. In particular, the control device may thus also be referred to as a controlling device and/or a regulation device.

Further advantages, features and details of the invention will be apparent from the following description, in which embodiments of the invention are described in detail with reference to the drawings. The features mentioned in the claims and in the description may each be essential to the invention individually or in any combination. It shows schematically:

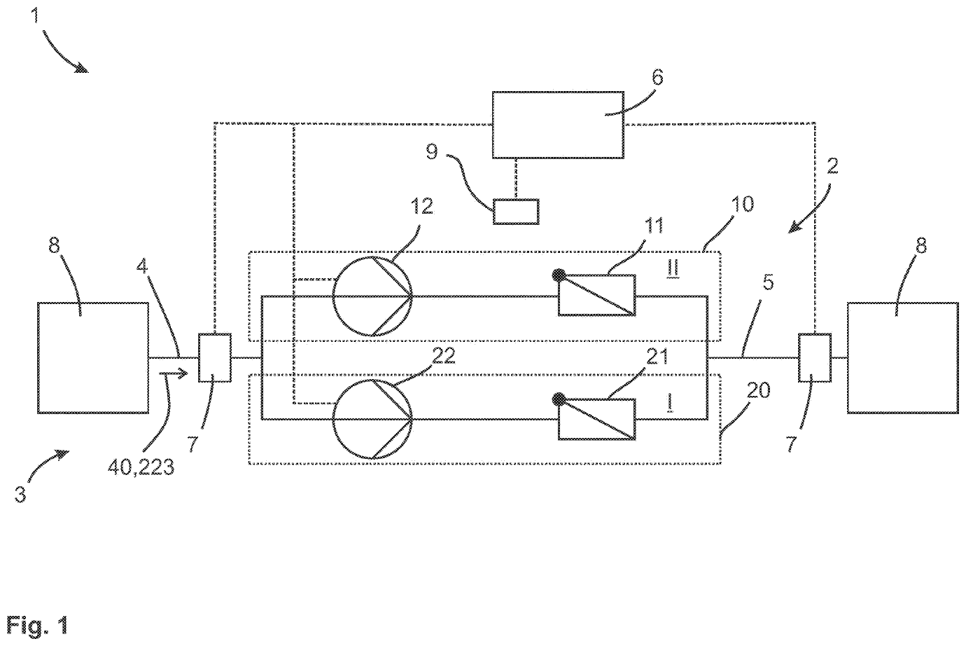

FIG. 1A flow system according to the invention for carrying out a method according to the invention for processing operating data of a flow arrangement of an apparatus of the flow system,

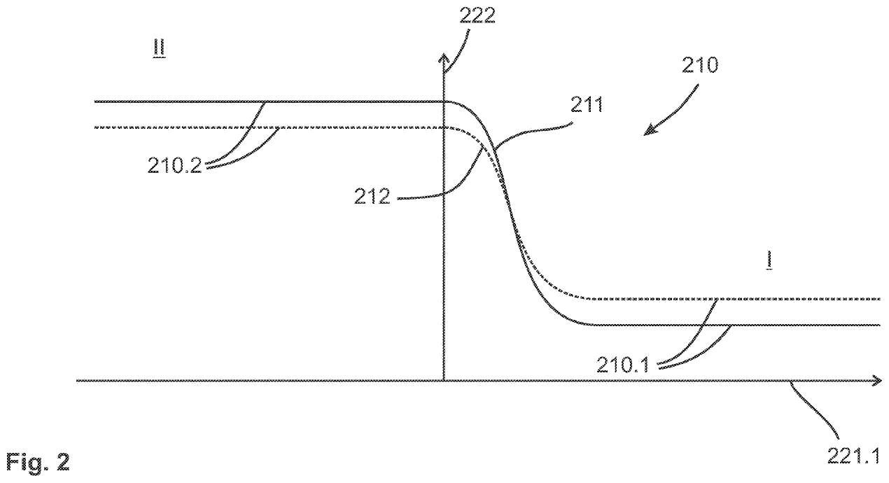

FIG. 2A resistance behavior of the flow arrangement,

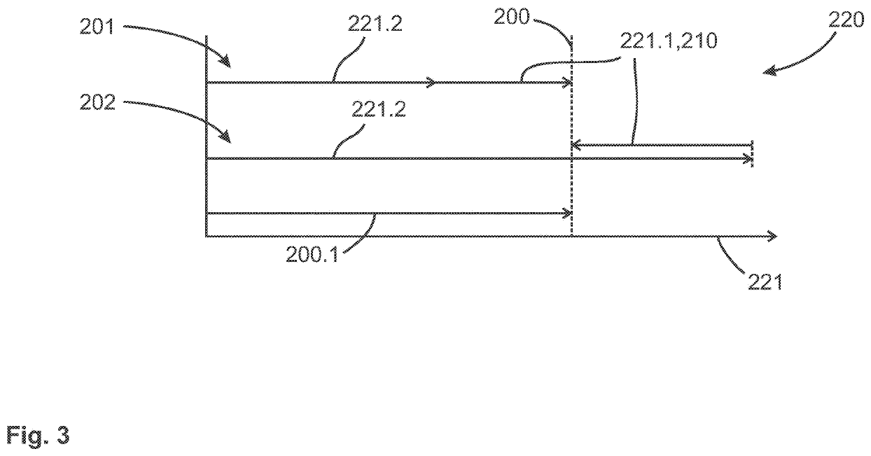

FIG. 3A substitute model for determining a strand-related operating behavior,

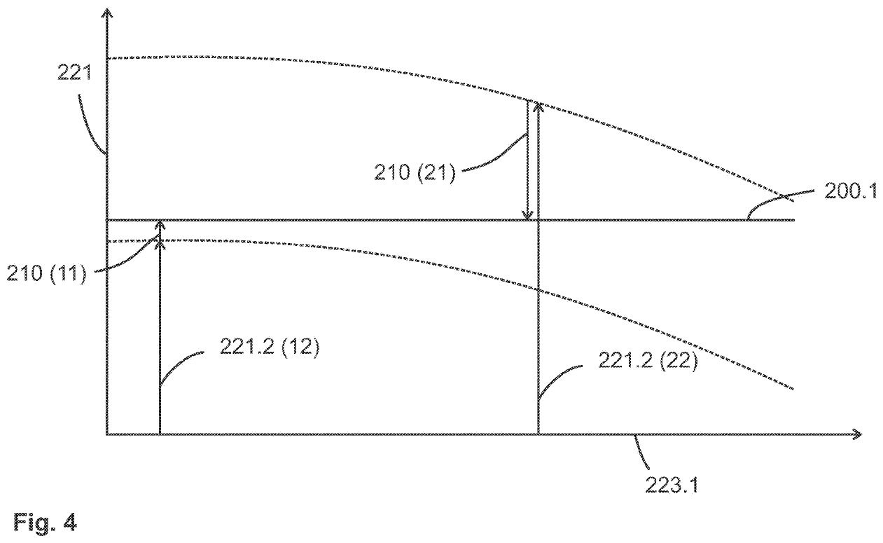

FIG. 4 Characteristic curves of flow machines of the flow arrangement,

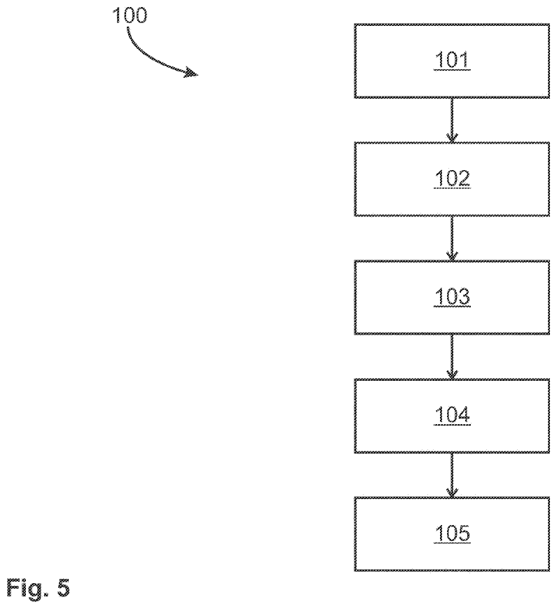

FIG. 5A schematic representation of method steps/stages, and

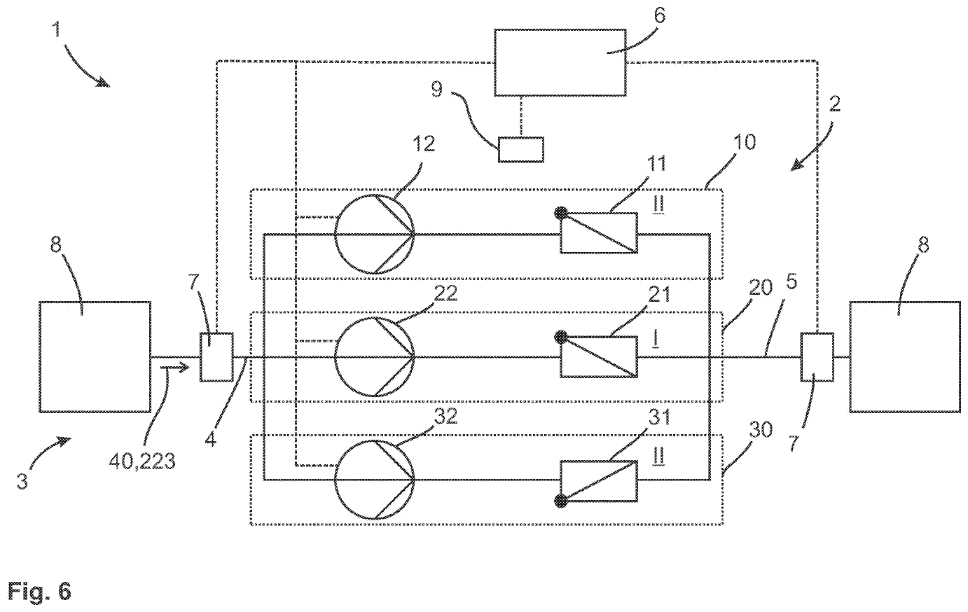

FIG. 6A flow system according to the invention for carrying out the method in a further embodiment.

In the following description of some embodiments of the invention, the identical reference signs are used for the same technical features even in different embodiments.

FIG. 1 shows a flow system 1 according to the invention, which has an apparatus 3 with a flow arrangement 2 for a fluid flow 40 between two apparatus parts 8. It is conceivable that the apparatus parts 8 are connected and form a fluid cycle with the flow arrangement 2. The flow arrangement 2 comprises a first conveying line 10, which has a first flow resistor 11, and a second conveying line 20, which has a second flow resistor 21. Thereby, the first conveying line 10 and the second conveying line 20 are connected in parallel to each other, in particular hydraulically, for the fluid flow 40. Furthermore, the flow arrangement 2 has a flow inlet 4 and a flow outlet 5. The flow inlet 4 forms a common access for the fluid flow 40 to the first conveying line 10 and to the second conveying line 20 from one of the apparatus parts 8, and the flow outlet 5 forms a common outlet from the first conveying line 10 and from the second conveying line 20 to the further apparatus part 8 of the apparatus 3. As a result, the first conveying line 10 and the second conveying line 20 have a common operating behavior 200, in which the first conveying line 10 and the second conveying line have an equal pressure difference between the flow inlet 4 and the flow outlet 5. Furthermore, a volume flow 223 preferably coincides at the flow inlet 4 and the flow outlet and thus also characterizes the common operating behavior 200.

The first conveying line 10 has a first flow machine 12 connected in series with the first flow resistor 11 within the first conveying line 10. The second conveying line 20 has a second flow machine 22, which is connected in series with the second flow resistor 21 within the second conveying line 20. Preferably, the first flow machine 12 and the second flow machine 22 are configured as a pump. Furthermore, the first flow resistor 11 and the second flow resistor 21 are each formed by a check valve. In this case, the first flow resistor 11 and the second flow resistor 21 can each be brought into an opening state I for allowing a flow in the respective conveying line and a closing state II for blocking a flow in the respective conveying line.

Further, the system comprises a control device 6 for executing a method 100 according to the invention for processing operating data of a flow arrangement 2 of the apparatus 3. The control device 6 may be part of the apparatus 3 or may be implemented separately from the apparatus 3, for example as part of an external server or a cloud. Preferably, a computer program product is provided comprising instructions which, when executed by the control device 6, cause the control device 6 to execute the method 100. The method 100 is shown in schematic representation of method steps/stages in FIG. 5.

In the method 100, a detection 101 of a resistance behavior 210 of the flow arrangement 2 is carried out with a first reference behavior 211 of the first flow resistor 11 and a second reference behavior 212 of the second flow resistor 21. The resistance behavior 210 is exemplarily shown in FIG. 2 on the basis of characteristic curves of the first reference behavior 211 and the second reference behavior 212 with a differential pressure 221.1 compared to a pressure drop FIG. 222 at the first flow resistor 11 and at the second flow resistor 21, respectively. Here, the first reference behavior 211 of the first flow resistor 11 and the second reference behavior 212 of the second flow resistor 21 each comprise a minimum reference parameter 210.1 for characterizing the opening state I and a maximum reference parameter 210.2 for characterizing the closing state II. The opening state I can, for example, be characterized by the minimum reference parameter 210.1 in the form of a low pressure drop FIG. 222 and the closing state II can be characterized by the maximum reference parameter 210.2 in the form of a high pressure drop FIG. 222.

Furthermore, the method 100 comprises detecting 102 a common operating behavior 200 with at least one common operating parameter 200.1 of the first conveying line 10 and the second conveying line 20 as a function of a current operating situation. The common operating parameter 200.1 may comprise the pressure difference between the flow inlet 4 and the flow outlet 5 and/or the volume flow 223 at the flow inlet 4 and/or at the flow outlet 5. It is conceivable that only one common operating parameter 200.1 for detecting 102 the common operating behavior 200 is detected, or multiple operating parameters.

Furthermore, the common operating parameter 200.1 may be measured in the apparatus 3, in particular by a sensor system 7 of the apparatus 3 and/or the flow arrangement 2, to analyze the operation and/or configuration of the apparatus 3. Alternatively, the common operating parameter 200.1 may be provided virtually at the control device 6 or by the control device 6, for example to simulate the operation and/or configuration of the apparatus 3.

Subsequently, in the method 100, a determination 103 of a, preferably structureless, substitute model 220 for determining a strand-related operating behavior 201, 202 of the flow arrangement 2 is carried out. By means of the substitute model 220, a mutual influence of the first conveying line 10 and the second conveying line 20 is taken into account as a function of the resistance behavior 210 and the common operating behavior 200, in particular for the current operating situation. The consideration of the mutual influence of the first conveying line 10 and the second conveying line 20 is thereby carried out on the basis of a respective differential pressure direction at the first flow resistor 11 and at the second flow resistor 21 in the substitute model 220. The strand-related operating behavior 201, 202 thereby comprises in particular a first operating behavior 201 of the first conveying line 10 and a second operating behavior 202 of the second conveying line 20. For example, as shown in FIG. 3, the first flow machine 12 and the second flow machine 22 may have different differential pressures 221.2 in the form of delivery pressures for delivering the fluid flow 40 in the current operating situation. As a result, the first flow resistor 11 is in the closing state II and the second flow resistor 21 is in the opening state I in the current operating situation. A differential pressure 221 of the common operating behavior 200 therefore comprises, for each of the conveying lines 10, 20, the respective differential pressure 221.2 at the first and second flow machines 12, 22 and the respective differential pressure 221.1 at the first and second flow resistors 11, 21. The differential pressures 221.1 at the first and second flow resistors 11, 21 have different differential pressure directions here. Based on the differential pressure direction, an adaptation of the respective strand-related differential pressure 221.1, 221.2 to the first operating parameter 200.1, in particular in the form of the differential pressure 221 of the common operating behavior 200, therefore takes place in the substitute model 220. For this purpose, a raising of a lower delivery pressure of the first conveying line 10 to a higher delivery pressure of the second conveying line 20 can take place. Due to the differential pressure direction, therefore, a pressure gain of the first conveying line 10, in particular at the first flow resistor 11, and a pressure loss at the second conveying line 20, in particular at the second flow resistor 21, can be taken into account in the substitute model 220, so that the first conveying line 10 and the second conveying line have the same pressure difference with respect to the flow inlet 4 and the flow outlet 5. FIG. 4 shows the substitute model 220 based on conveying characteristics of the first flow machine 12 and the second flow machine 22 with a differential pressure 221 with respect to a strand-related volume flow 223.1.

As a function of the substitute model 220, a determination 104 of the strand-related operating behavior 201, 202 of the flow arrangement 2 for the current operating situation is further performed. For this purpose, the determination 104 of the strand-related operating behavior 201, 202 can be carried out iteratively, in particular as a function of a predefined initial condition, by evaluating the substitute model 220 iteratively. As a result, when determining 104 the strand-related operating behavior 201, 202, at least one, preferably several or all, of the following operating parameters of the flow arrangement 2 can be calculated for the first conveying line 10 and the second conveying line 20 of the current operating situation. For example, a strand-related volume flow 223.1, a differential pressure 221.1 at the first flow resistor 11 and/or at the second flow resistor 21, a differential pressure 221.2 at the first flow machine 12 and/or at the second flow machine 22, a strand-related delivery head and/or a pressure drop FIG. 222 for the first flow resistor 11 and/or second flow resistor 21 can be calculated in each case for the first conveying line 10 and the second conveying line 20.

As a function of the strand-related operating behavior 201, 202, a reaction process 105 may further be executed. The reaction process 105 may comprise, for example, a control of the first flow machine 12 and the second flow machine 22, an output of a service life forecast for the flow arrangement 2 and/or a display of the strand-related operating behavior 201, 202 at an operating device 9 of the apparatus 3.

By means of the method 100, a current configuration of the flow arrangement 2 can be analyzed in knowledge of the resistance behavior 210 and the common operating behavior 200 and, in particular, in ignorance of individual strand-related operating parameters. For example, strand-related operating parameters of the flow resistors and/or further components of the conveying lines can be identified and/or calculated in this process. In this way, for example, proof of the current configuration of the flow arrangement 2 can be provided for clarifying warranty issues without having to retrofit the apparatus 3. Since it has also been recognized in the context of the present invention that the differential pressure direction in the substitute model 220 can be used to take into account an increase in a lower delivery pressure of one of the conveying lines to a higher delivery pressure of the respective other conveying line, the strand-related operating behavior 201, 202 of the flow arrangement 2 can also be calculated for different delivery pressures in the conveying lines, in particular without intervening by means of a manual case discrimination.

FIG. 6 shows a flow system 1 according to the invention, which comprises an apparatus 3 with a flow arrangement 2 for a fluid flow 40 between two apparatus parts 8, in a further embodiment. The flow system 1 further comprises a control device 6 for carrying out a method 100 according to the invention for processing operating data of a flow arrangement 2 of the apparatus 3. The method 100 and the flow system 1 substantially correspond to the first embodiment example. However, in this case, the flow arrangement 2 further comprises at least a third conveying line 30 having a third flow resistor 31 and a third flow machine 32. The third conveying line 30 is connected in parallel with the first conveying line and second conveying line 20. Thereby, a third reference behavior of the third flow resistor 31 is further detected when detecting 101 a resistance behavior 210. Further, a mutual influence of the first conveying line 10, the second conveying line 20, and the third conveying line 30 is considered in determining 103 a substitute model 220.

The foregoing explanation of the embodiments describes the present invention exclusively in the context of examples. Of course, individual features of the embodiments may be freely combined with one another, provided that this is technically expedient, without departing from the scope of the present invention.

### LIST OF REFERENCE SIGNS

1 Flow system
2 Flow arrangement
3 Apparatus
4 Flow inlet
5 Flow outlet
6 Control device
7 Sensor system
8 Apparatus part
9 Operating device
10 First conveying line
11 First flow resistor
12 First flow machine
20 Second conveying line
21 Second flow resistor
22 Second flow machine
30 Third conveying line
31 Third flow resistor
32 Third flow machine
40 Fluid flow
200 Common operating behavior
200.1 First operating parameter
201 First operating behavior
202 Second operating behavior
210 Resistance behavior
210.1 Minimum reference parameter
210.2 Maximum reference parameter
211 First reference behavior
212 Second reference behavior
100 Method
101 Detection of 210
102 Detection of 200
103 Determining 220
104 Determining 201, 202
105 Reaction process
220 Substitute model
221 Differential pressure
221.1 Differential pressure at 11 or 21
221.2 Differential pressure at 12 or 22
222 Pressure drop FIG.
223 Volume flow
223.1 Strand-related volume flow
I Opening state
II Closing state

1. A method for processing operating data of a flow arrangement of an apparatus with a first conveying line, which has a first flow resistor, and a second conveying line, which has a second flow resistor and is connected in parallel with the first conveying line for a fluid flow in the flow arrangement, wherein the method comprises:
detecting a resistance behavior of the flow arrangement with a first reference behavior of the first flow resistor and a second reference behavior of the second flow resistor,
detecting a common operating behavior with at least one common operating parameter of the first conveying line and the second conveying line as a function of a current operating situation,
determining a substitute model for determining a strand-related operating behavior of the flow arrangement, in which a mutual influence of the first conveying line and the second conveying line is taken into account as a function of the resistance behavior and the common operating behavior,
determining the strand-related operating behavior of the flow arrangement for the current operating situation as a function of the substitute model.

2. The method according to claim 1, wherein the first conveying line has a first flow machine and the second conveying line has a second flow machine, at least the first flow machine being connected in series with the first flow resistor or the second flow machine being connected in series with the second flow resistor.

3. The method according to claim 2, wherein at least the first flow machine or the second flow machine is configured as a pump, the first flow machine and the second flow machine having different differential pressures in the form of delivery pressures for delivering the fluid flow in the current operating situation.

4. The method according to claim 1, wherein the first flow resistor and the second flow resistor can each be brought into an opening state for allowing a flow and a closing state for blocking a flow, the first flow resistor being in the closing state in the current operating situation and the second flow resistor being in the opening state.

5. The method according to claim 1, wherein at least the first reference behavior or the second reference behavior each comprises at least a minimum reference parameter for characterizing the opening state or a maximum reference parameter for characterizing the closing state.

6. The method according to claim 1, wherein the first flow resistor and the second flow resistor are each formed by a check valve.

7. The method according to claim 1, wherein the flow arrangement has a flow inlet and a flow outlet, the common operating behavior comprising at least a pressure difference between the flow inlet and the flow outlet or a volume flow at least at the flow inlet or at the flow outlet.

8. The method according to claim 1, wherein the mutual influence of the first conveying line and the second conveying line is taken into account in the substitute model by means of a differential pressure direction at the first flow resistor and at the second flow resistor, respectively.

9. The method according to claim 1, wherein when determining the strand-related operating behavior, at least one of the following operating parameters of the flow arrangement is calculated for the first conveying line and the second conveying line of the current operating situation:
strand-related volume flow,
differential pressure at least at the first flow resistor or at the second flow resistor,
differential pressure at least at the first flow machine or at the second flow machine,
strand-related delivery head,
pressure drop figure for at least the first flow resistor or the second flow resistor.

10. The method according to claim 1, wherein the determination of the strand-related operating behavior is carried out iteratively.

11. The method according to claim 1, wherein the flow arrangement has at least one third conveying line with a third flow resistor, which is connected in parallel with the first conveying line and second conveying line, a third reference behavior of the third flow resistor being detected when the resistance behavior is detected.

12. The method according to claim 1, wherein the common operating parameter is measured or virtually provided in the apparatus.

13. The method according to claim 1, wherein a reaction process is carried out as a function of the strand-related operating behavior.

14. A computer program product comprising instructions that, when executed by a control device, cause the control device to execute a method according to claim 1.

15. A flow system comprising,
an apparatus with a flow arrangement comprising a first conveying line having a first flow resistor and a second conveying line having a second flow resistor and being connected in parallel to the first conveying line for a fluid flow in the flow arrangement, and
a control device for carrying out a claim 1.
